(19) United States
(12) Patent Application Publication
(10) Pub. No.: US 2026/0189312 A1
(43) Pub. Date: Jul. 2, 2026

(54) APPARATUS AND METHOD FOR SETTING SEPARATION DISTANCE BETWEEN AERIAL NETWORK COMMUNICATION SYSTEMS

(71) Applicant: ELECTRONICS AND TELECOMMUNICATIONS RESEARCH INSTITUTE, Daejeon (KR)

(72) Inventors: Hyun Duk KANG, Daejeon (KR); Ho Kyung SON, Daejeon (KR); Cheol Ho SHIN, Daejeon (KR); Young Keun YOON, Daejeon (KR)

(21) Appl. No.: 19/374,137

(22) Filed: Oct. 30, 2025

(30) Foreign Application Priority Data
Dec. 26, 2024 (KR) 10-2024-0197713

(51) Int. Cl. H04B 17/345; H04B 7/185

(52) U.S. Cl. CPC H04B 17/345; H04B 7/18502

(57) ABSTRACT

The present invention relates to a method of setting a separation distance between aerial network communication systems. The method of setting a separation distance includes calculating, by a processor, an interference probability in an overlapping area between ground cells of a first aerial network communication system and a second aerial network communication system using at least one parameter of the first aerial network communication system and the second aerial network communication system; and setting, by the processor, a separation distance between the aerial network communication systems based on the interference probability.

### CROSS-REFERENCE TO RELATED APPLICATION

This application claims priority to and the benefit of Korean Patent Application No. 10-2024-0197713, filed on Dec. 26, 2024, the disclosure of which is incorporated herein by reference in its entirety.

### BACKGROUND

### 1. Field of the Invention

The present invention relates to a method and an apparatus for setting a separation distance between aerial network communication systems.

### 2. Discussion of Related Art

Aerial networks, which utilize satellites, drones, airplanes, and balloons to expand the existing two-dimensional plane-based communication area to three-dimensions in the upcoming 6th generation (6G) mobile communication, can provide communication in areas where terrestrial networks have difficulty transmitting signals.

Aerial networks can provide a seamless communication environment, even in communication dead zones such as deserts, oceans, or mountainous regions, or during disasters. In addition, aerial networks may provide high bandwidth and low latency between geographically dispersed or mobile devices, thereby enabling real-time data transmission even over long distances. Unlike terrestrial networks, aerial networks are not subject to geographical restrictions, enabling communication in remote or overseas regions and facilitating rapid response in emergency situations.

However, when multiple aerial networks are deployed in adjacent areas, mutual interference occurs, leading to a decrease in frequency utilization efficiency. Accordingly, there is a need to improve this issue.

The background art of the present invention is disclosed in Korean Laid-Open Patent No. 10-2121164, published on Jun. 3, 2020.

### SUMMARY OF THE INVENTION

The present invention is directed to an apparatus and a method for setting a separation distance between aerial network communication systems, which minimize interference between adjacent aerial network communication systems and improve frequency utilization efficiency by setting a separation distance between aerial network communication systems according to the interference probability caused by overlapping ground-cell coverage.

According to an aspect of the present invention, there is provided an apparatus for setting a separation distance between aerial network communication systems, which includes a processor; and a memory configured to store instructions executed by the processor, wherein the processor calculates an interference probability in an overlapping area between ground cells of a first aerial network communication system and a second aerial network communication system using at least one parameter of the first aerial network communication system and the second aerial network communication system, and sets a separation distance between the aerial network communication systems based on the interference probability.

According to the present invention, the first aerial network communication system may be a high altitude platform station (HAPS), and the second aerial network communication system may be an unmanned aerial vehicle (UAV).

According to the present invention, the parameter may include at least one of a beamwidth of the first aerial network communication system and the second aerial network communication system, an altitude of the first aerial network communication system and the second aerial network communication system, a ground cell radius of the first aerial network communication system and the second aerial network communication system, a ground cell service coverage of the first aerial network communication system and the second aerial network communication system, an elevation angle of the second aerial network communication system with respect to a user of the first aerial network communication system located at coordinates in a three-dimensional (3D) space of a ground cell of the first aerial network communication system, a zenith angle of the second aerial network communication system with respect to the a of the earth, a distance between the first aerial network communication system and the second aerial network communication system, a distance between ground cells of the first aerial network communication system and the second aerial network communication system, and a radius of the ground cells of the first aerial network communication system and the second aerial network communication system.

According to the present invention, the processor may calculate the overlapping area using at least one of a separation distance between centers and radii of the ground cells of the first aerial network communication system and the second aerial network communication system.

According to the present invention, the processor may set the separation distance between the aerial network communication systems based on a comparison result between the interference probability and a predetermined target interference probability corresponding to the overlapping area.

According to the present invention, the processor may maintain the separation distance to determine whether the target interference probability changes, when the interference probability matches the target interference probability.

According to the present invention, the processor may adjust the parameter to increase the separation distance between the aerial network communication systems when the interference probability is greater than the target interference probability, and adjust the parameter to decrease the separation distance between the aerial network communication systems when the interference probability is less than the target interference probability.

According to the present invention, the separation distance between the aerial network communication systems may be a separation distance between the first aerial network communication system and the second aerial network communication system.

According to the present invention, the separation distance between the first aerial network communication system and the second aerial network communication system may be calculated based on the predetermined target interference probability according to the overlapping area of the first aerial network communication system and the second aerial network communication system.

According to the present invention, the separation distance between the aerial network communication systems may be a separation distance between a user located at a center of a ground-cell coverage of the first aerial network communication system and the second aerial network communication system.

According to the present invention, the separation distance between the user located at the center of the ground-cell coverage of the first aerial network communication system and the second aerial network communication system may be calculated based on a predetermined target interference probability according to an overlapping area of the user located at the center of the ground-cell coverage of the first aerial network communication system and the second aerial network communication system.

According to another aspect of the present invention, there is provided a method of setting a separation distance between aerial network communication systems, which includes: calculating, by a processor, an interference probability in an overlapping area between ground cells of a first aerial network communication system and a second aerial network communication system using at least one parameter of the first aerial network communication system and the second aerial network communication system; and setting, by the processor, a separation distance between the aerial network communication systems based on the interference probability.

According to the present invention, the parameter may include at least one of a beamwidth of the first aerial network communication system and the second aerial network communication system, an altitude of the first aerial network communication system and the second aerial network communication system, a ground cell radius of the first aerial network communication system and the second aerial network communication system, a ground cell service coverage of the first aerial network communication system and the second aerial network communication system, an elevation angle of the second aerial network communication system with respect to a user of the first aerial network communication system located at coordinates in a 3D space of a ground cell of the first aerial network communication system, a zenith angle of the second aerial network communication system with respect to a center of the earth, a distance between the first aerial network communication system and the second aerial network communication system; a distance between ground cells of the first aerial network communication system and the second aerial network communication system, and a radius of the ground cells of the first aerial network communication system and the second aerial network communication system.

According to the present invention, the calculating of the interference probability may include calculating, by the processor, the overlapping area using at least one of a separation distance between centers and radii of the ground cells of the first aerial network communication system and the second aerial network communication system.

According to the present invention, the setting of the separation distance between the aerial network communication systems may include, by the processor, comparing the interference probability and a predetermined target interference probability corresponding to the overlapping area, and correcting the separation distance between the aerial network communication systems according to a result of the comparing.

According to the present invention, the setting of the separation distance between the aerial network communication systems may include, by the processor, maintaining the separation distance to determine whether the target interference probability changes when the interference probability matches the target interference probability, and adjusting the parameter to increase the separation distance between the aerial network communication systems when the interference probability is greater than the target interference probability and adjusting the parameter to decrease the separation distance between the aerial network communication systems when the interference probability is less than the target interference probability.

According to the present invention, the separation distance between the aerial network communication systems may be a separation distance between the first aerial network communication system and the second aerial network communication system.

According to the present invention, the separation distance between the first aerial network communication system and the second aerial network communication system may be calculated based on the predetermined target interference probability according to the overlapping area of the first aerial network communication system and the second aerial network communication system.

According to the present invention, the separation distance between the aerial network communication systems may be a separation distance between a user located at a center of the ground-cell coverage of the first aerial network communication system and the second aerial network communication system.

According to the present invention, the separation distance between the user located at the center of the ground-cell coverage of the first aerial network communication system and the second aerial network communication system may be calculated based on a predetermined target interference probability according to an overlapping area of the user located at the center of the ground-cell coverage of the first aerial network communication system and the second aerial network communication system.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an apparatus for setting a separation distance between aerial network communication systems according to an embodiment of the present invention;

FIG. 2 illustrates an example of interference between heterogeneous aerial networks;

FIG. 3 illustrates a structure of a canonical beam used in a high altitude platform station (HAPS) and unmanned aerial vehicle (UAV) aerial network systems, based on the example of interference between the aerial networks described in FIG. 2;

FIG. 4 illustrates an example of interference between a HAPS aerial network system and a UAV aerial network system, which are adjacent to each other;

FIGS. 5A, 5B, and 5C illustrate a case in which a ground-cell coverage of adjacent HAPS aerial network systems having different beamwidths and ground cell radii overlaps with a ground-cell coverage of a UAV aerial network system, based on the example of interference described in FIG. 4; and

FIG. 6 is a flowchart illustrating a method of setting a separation distance between aerial network communication systems according to one embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, examples of an apparatus and method for setting a separation distance between aerial network communication systems according to embodiments of the present invention will be described.

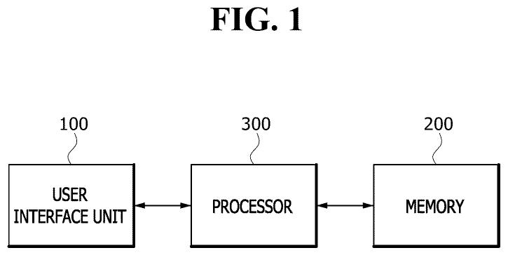

FIG. 1 is a block diagram illustrating an apparatus for setting a separation distance between aerial network communication systems according to an embodiment of the present invention.

Referring to FIG. 1, the apparatus for setting a separation distance between aerial network communication systems according to the embodiment of the present invention may include a user interface unit 100, a memory 200, and a processor 300.

The user interface unit 100 may provide a user interface. The user interface unit 100 may receive, from a user, parameters for setting a separation distance between aerial network communication systems. The parameters will be described below.

The aerial network communication system may be a low earth orbit (LEO) satellite at an altitude of 600 km, a high altitude platform station (hereinafter, referred to as “HAPS”) at an altitude of 20 km, a high altitude platform station for an IMT base station (HIBS), an air-to-ground (ATG) network at an altitude of 10 km, or an unmanned aerial vehicle (UAV) at an altitude of 150 m. In this embodiment, the HAPS and UAV are described as examples of aerial network communication systems.

The HAPS may stay in a quasi-stationary position at an altitude of 20 km to 50 km within the stratosphere and may provide ubiquitous connectivity and broadband wireless communication services to ground users located over a relatively wide area.

An aerial network utilizing a UAV may provide on-demand access services to ground users located over a relatively narrow area at an altitude of 150 m. In the aerial network utilizing a UAV, the operating range may be limited due to energy constraints, and altitude maintenance capabilities and flight time for providing aerial network services may be restricted, resulting in variable connectivity conditions.

In the present embodiment, examples of a HAPS and a UAV are described, however, the technical scope of the present invention is not limited thereto, and various aerial network communication systems may be applied.

The user interface unit 100 may output an interference probability in an overlapping area between ground cells of the HAPS and the UAV, and a separation distance of the aerial network communication system which is set according to the interference probability. In addition, the user interface unit 100 may include an interface for calculating the separation distance between the aerial network communication systems and may input and output various types of information.

The user interface unit 100 may include, for example, a keyboard, a mouse, a touch pad, a touch screen, an electronic pen, or touch buttons. The user interface unit 100 may also include a printer or a display for outputting data. Here, the display may be implemented as, for example, a thin film transistor-liquid crystal display (TFT-LCD) panel, a light emitting diode (LED) panel, an organic light emitting diode (OLED) panel, an active matrix OLED (AMOLED) panel, or a flexible panel.

The memory 200 may store various types of data used by the processor 300. The data may include instructions for performing operations or steps according to an embodiment of the present invention. That is, the memory 200 may store instructions for setting a separation distance between the aerial network communication systems according to an interference probability caused by overlapping ground-cell coverage. The memory 200 may include at least one storage medium among a flash memory type memory, a hard disk type memory, a multimedia card micro type memory, a card-type memory, a random access memory (RAM), a static random access memory (SRAM), a read-only memory (ROM), a programmable read-only memory (PROM), an erasable programmable read-only memory (EPROM), and an electrically erasable programmable read-only memory (EEPROM).

The processor 300 may be connected to the memory 200 and execute instructions stored in the memory 200. By executing the instructions stored in the memory 200, the processor 300 may control at least one other component (e.g., a hardware or software component) connected to the processor 300 and perform various data processing or computation operations.

In addition, the processor 300 may be formed such that the configuration for performing each function is implemented at the hardware, software, or logic level. In such a case, dedicated hardware for performing each function may be used. For this purpose, the processor 300 may be implemented as at least one of an application specific integrated circuit (ASIC), a digital signal processor (DSP), a programmable logic device (PLD), a field programmable gate array (FPGA), a central processing unit (CPU), a microcontroller, and/or a microprocessor.

The processor 300 may be implemented as a central processing unit (CPU) or a system on chip (SoC), control a plurality of hardware or software components connected to the processor 300 by executing an operating system or an application, and perform various data processing and computation operations. The processor 300 may be configured to execute at least one instruction stored in the memory 200 and store result data of the execution in the memory 200.

The processor 300 may calculate an interference probability in an overlapping area between ground cells of the HAPS and the UAV using at least one parameter of the HAPS and the UAV and set a separation distance between the aerial network communication systems according to the interference probability. A detailed description thereof will be provided below.

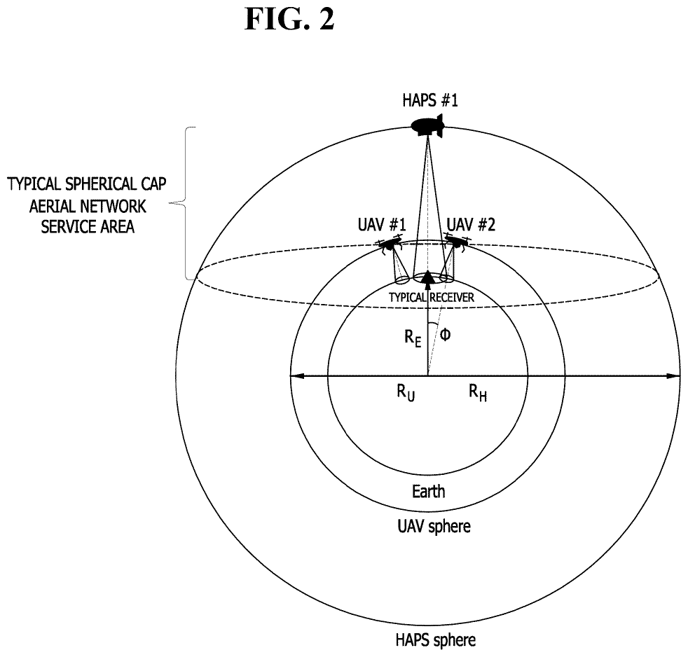

FIG. 2 illustrates an example of interference between heterogeneous aerial networks.

Referring to FIG. 1, a HAPS communicates with ground users on the ground surface by using a cylindrical beam directed toward the center of the Earth, resulting in a circular ground cell. A representative aerial network user (or typical receiver) located at coordinates (0, 0, R_{E}) in a three-dimensional space is positioned at the center of the ground-cell coverage of HAPS #1. HAPS #1 is located at the zenith of the aerial network user, and the typical receiver, with respect to HAPS #1, is located at the nadir. A UAV is operated at a relatively lower altitude (around 150 m) than the HAPS. The UAV may be positioned adjacent to the ground-cell coverage of HAPS #1. It is assumed that the UAV employs a conical beam whose beam axis is aligned with the center of the Earth and directed toward the ground, and the resulting ground cell also has a circular shape, similar to that of the HAPS.

Here, when the UAV and the HAPS use the same frequency band and the positions of their ground cells are adjacent to each other, an overlapping area may be formed between the adjacent ground cells depending on their positions, thereby causing interference.

UAV #2 has a zenith angle q with respect to the center of the Earth, and the ground-cell coverage of HAPS #1 overlaps with the ground-cell coverage of UAV #2. The ground-cell coverage of UAV #1 is located in a region that does not overlap with the ground-cell coverage of HAPS #1. As UAV #1 and UAV #2 move, the overlapping area with the ground-cell coverage of HAPS #1 may vary.

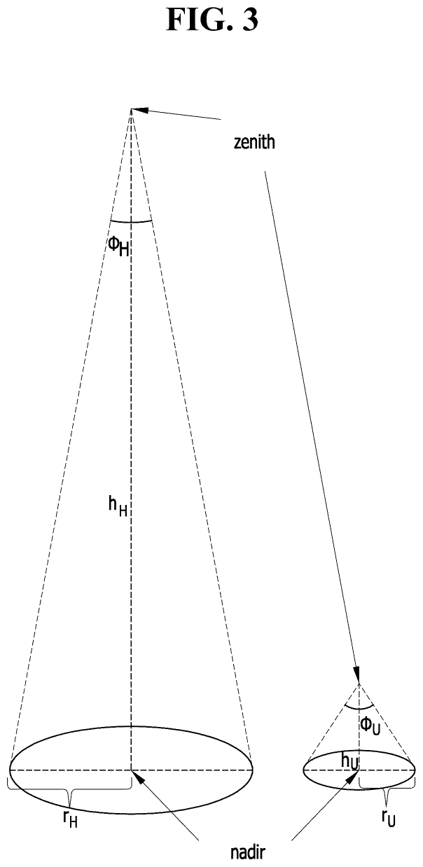

FIG. 3 illustrates a structure of a canonical beam used in a HAPS and UAV aerial network systems, based on the example of interference between the aerial networks described in FIG. 2. Beamwidths φH and φU of the conical beams of the HAPS and the UAV, each having a circular ground-cell shape, may be calculated using altitudes h_{H} and h_{U} of the HAPS and the UAV, and radii r_{H} and r_{U} of the ground cells of the HAPS and the UAV, as shown in Equations 1 and 2 below.

$${φ}_{H} = 2 \cdot {tan}^{- 1} ( \frac{{r}_{H}}{{h}_{H}} ) \qquad [ Equation 1 ]$$

The beamwidth φ_{U} of the conical beam of the UAV having a circular ground-cell shape may be calculated using the altitude h_{U} of the UAV and the radius r_{U} of the ground cell of the UAV, as shown in Equation 2 below.

$${φ}_{U} = 2 \cdot {tan}^{- 1} ( \frac{{r}_{U}}{{h}_{U}} ) {φ}_{U} = 2 \cdot {tan}^{- 1} ( \frac{{r}_{U}}{{h}_{U}} ) \qquad [ Equation 2 ]$$

The radius TH of the ground cell of the HAPS may be calculated using the altitude h_{H} of the HAPS and the beamwidth φ_{H} of the HAPS beam, as shown in Equation 3 below.

$${r}_{H} = {h}_{H} \cdot tan ( \frac{{φ}_{H}}{2} ) \qquad [ Equation 3 ]$$

The radius r_{U} of the ground cell of the UAV may be calculated using the altitude h_{U} of the UAV and the beamwidth φU of the UAV beam, as shown in Equation 4 below.

$${r}_{U} = {h}_{U} \cdot tan ( \frac{{φ}_{U}}{2} ) \qquad [ Equation 4 ]$$

A service coverage C_{H} of the ground cell of the HAPS may be calculated using the altitude h_{H} of the HAPS and the beamwidth φ_{H} of the HAPS beam, as shown in Equation 5 below.

$${C}_{H} = π \cdot {( {h}_{H} \cdot tan ( \frac{{φ}_{H}}{2} ) )}^{2} \qquad [ Equation 5 ]$$

A service coverage C_{U} of the ground cell of the UAV may be calculated using the altitude h_{U} of the UAV and the beamwidth φ_{U} of the UAV beam, as shown in Equation 6 below.

$${C}_{U} = π \cdot {( {h}_{U} \cdot tan ( \frac{{φ}_{U}}{2} ) )}^{2} \qquad [ Equation 6 ]$$

By using Equation 5, the beamwidth φ_{H} of the HAPS may be calculated using the service coverage C_{H} of the ground cell of the HAPS and the altitude h_{U} of the HAPS, as shown in Equation 7 below.

$${φ}_{H} = 2 \cdot {tan}^{- 1} ( \frac{\sqrt{{C}_{H} / π}}{{h}_{H}} ) \qquad [ Equation 7 ]$$

By using Equation 6, the beamwidth φ_{U} of the UAV may be calculated using the service coverage C_{U} of the ground cell of the UAV and the altitude h_{U} of the UAV, as shown in Equation 8 below.

$${φ}_{U} = 2 \cdot {tan}^{- 1} ( \frac{\sqrt{{C}_{U} / π}}{{h}_{U}} ) \qquad [ Equation 8 ]$$

An antenna gain of the conical beam of the HAPS may be calculated as shown in Equation 9 below.

$${G}_{H} ( φ ) = \{ \begin{matrix}min \{ {G}_{H}^{m ax} , \frac{1 - cos ( {φ}_{H}^{m ax} / 2 )}{1 - cos ( {φ}_{H} / 2 )} \} & for \vert {φ}_{H} \vert \leq {φ}_{H}^{m ax} , \\ 0 & otherwise ,\end{matrix} \qquad [ Equation 9 ]$$

An antenna gain of the conical beam of the UAV may be calculated as shown in Equation 10 below.

$${G}_{U} ( φ ) = \{ \begin{matrix}min \{ {G}_{U}^{m ax} , \frac{1 - cos ( {φ}_{U}^{m ax} / 2 )}{1 - cos ( {φ}_{H} / 2 )} \} & for \vert {φ}_{U} \vert \leq {φ}_{U}^{m ax} , \\ 0 & otherwise ,\end{matrix} \qquad [ Equation 10 ]$$

Here, a maximum value of the bandwidth of the HAPS may be calculated as shown in Equation 11 below.

$${φ}_{H}^{m ax} = {cos}^{- 1} ( \frac{{h}_{H}^{2} + 2 {h}_{H} {R}_{E} - {R}_{E}^{2}}{{( {R}_{E} + {h}_{H} )}^{2}} ) \qquad [ Equation 11 ]$$

A maximum value of the bandwidth of the UAV may be calculated as shown in Equation 12 below.

$${φ}_{U}^{m ax} = {cos}^{- 1} ( \frac{{h}_{U}^{2} + 2 {h}_{U} {R}_{E} - {R}_{E}^{2}}{{( {R}_{E} + {h}_{U} )}^{2}} ) \qquad [ Equation 12 ]$$

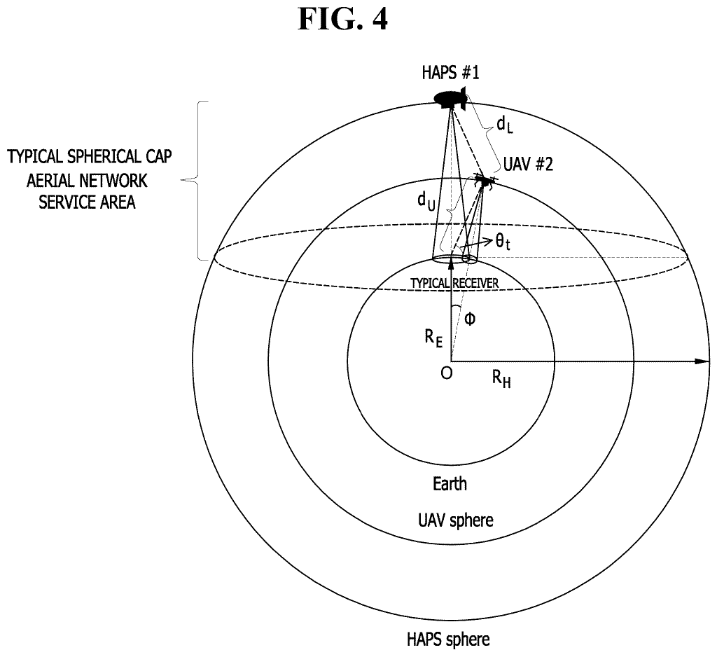

FIG. 4 illustrates an example of interference between a HAPS aerial network system and a UAV aerial network system adjacent to each other.

Referring to FIG. 4, various interference situations may occur depending on different parameter values, such as the altitudes h_{U} and h_{U} of the HAPS and the UAV, the beamwidths φ_{H} and φ_{U} of the HAPS and the UAV, an elevation angle θₜ of an adjacent UAV with respect to a reference aerial network located at Coordinates (0, 0, R_{E}) in a three-dimensional space, a zenith angle φ of the adjacent UAV with respect to the center of the Earth, a distance d_{L} (straight-line length) between the HAPS and the UAV, a distance d_{G·HU} between the two ground cells, the service coverages C_{H} and C_{U} of the ground cells of the HAPS and the UAV, and the radii r_{H} and r_{U} of the ground cells of the HAPS and UAV.

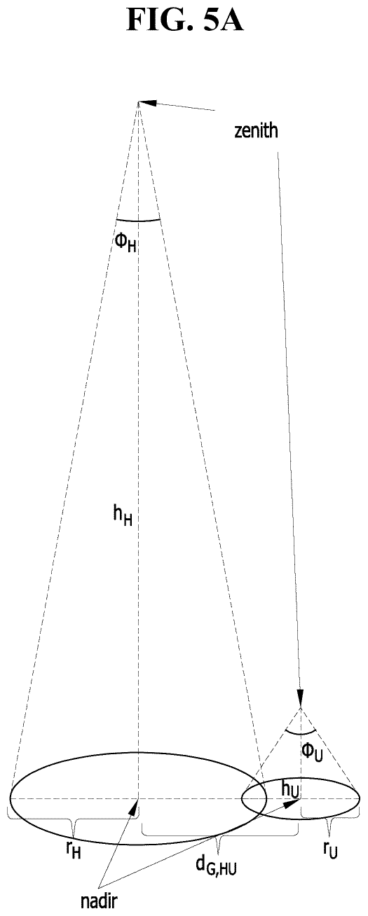

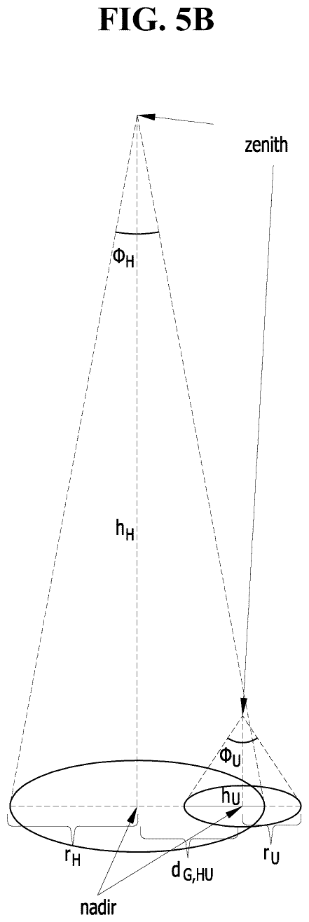

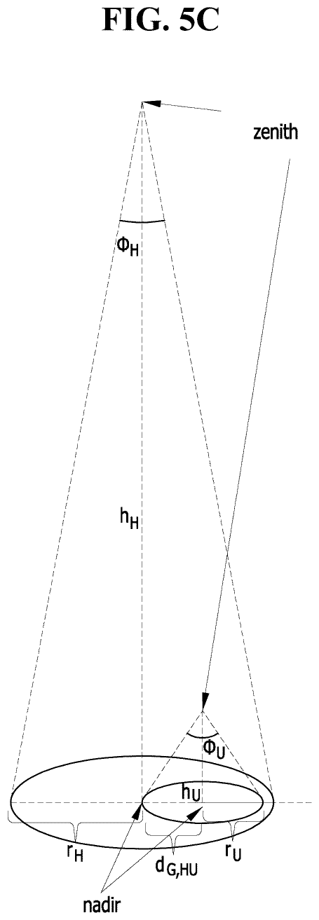

FIGS. 5A, 5B, and 5C illustrate a case in which a ground-cell coverage of adjacent HAPS aerial network systems having different beamwidths and ground cell radii overlaps with a ground-cell coverage of a UAV aerial network system, based on the example of interference described in FIG. 4.

Here, FIG. 5A illustrates a case in which the center of a ground-cell coverage of the UAV aerial network system is not included in the ground-cell coverage area of the HAPS. FIG. 5B illustrates a case in which the center of the ground-cell coverage of the UAV aerial network system is included in the ground-cell coverage area of the HAPS, but the entire ground-cell coverage of the UAV aerial network system is not included in the ground-cell coverage area of the HAPS. FIG. 5C illustrates a case in which the entire ground-cell coverage of the UAV aerial network system is completely included in the ground-cell coverage area of the HAPS.

The distance d_{G·HU} between the two ground cells may be calculated using parameters such as the altitudes h_{U} and h_{U} of the HAPS and the UAV, the elevation angle θₜ of an adjacent UAV with respect to the reference aerial network located at coordinates (0, 0, R_{E}) in a 3D space, the zenith angle φ of the adjacent UAV with respect to the center of the Earth, and the distance d_{L} (straight-line length) between the HAPS and the UAV, as shown in Equation 13 below.

$${d}_{G , HU} = \{ \begin{matrix}= {R}_{E} {cos}^{- 1} ( \frac{{R}_{E}^{2} ( 2 + {h}_{H}^{2} + {h}_{U}^{2} ) + 2 {R}_{E} ( {h}_{H} + {h}_{U} ) - {d}_{L}^{2}}{2 {R}_{E} ( {R}_{E} + {h}_{U} )} ) , w . r . t . {d}_{L} \\ = ϕ {R}_{E} , w . r . t . ϕ \\ = {R}_{E} [ {cos}^{- 1} ( \frac{{R}_{E}}{{R}_{E} + {h}_{U}} ) cos {θ}_{t} ] - {θ}_{t} , w . r . t . {θ}_{t} \\ = {R}_{E} {cos}^{- 1} ( \frac{{R}_{E}^{2} + {( {R}_{E} + {h}_{U} )}^{2} - {d}_{U}^{2}}{2 {R}_{E} ( {R}_{E} + {h}_{U} )} ) , w . r . t . {d}_{U}\end{matrix} \qquad [ Equation 13 ]$$

The overlapping area Oₐᵣₑₐ of the ground cells of the HAPS and UAV may be calculated using the separation distance d_{G·HU} between the centers of the ground cells of the HAPS and UAV and the radii r_{H} and r_{U} of the ground cells of the HAPS and UAV, as shown in Equation 14 below.

$${O}_{area} = \{ \begin{matrix}π {r}_{U}^{2} , & if {d}_{G , HU} = 0 ( fully overlapped ) \\ 0 , & if {d}_{G , HU} \geq 2 r ( non overlapped ) \\ {r}_{H}^{2} α + {r}_{U}^{2} ( π - β ) - \frac{1}{2} ( {r}_{U}^{2} sin 2 α - {r}_{U}^{2} sin 2 β ) , & if ( {r}_{H} - {r}_{U} ) < {d}_{G , HU} < {r}_{H} \cdot cos ( {sin}^{- 1} ( \frac{{r}_{U}}{{r}_{H}} ) ) \\ {r}_{H}^{2} β + {r}_{ij}^{2} α - \frac{1}{2} ( {r}_{ij}^{2} sin 2 α + {r}_{H}^{2} sin 2 β ) , & if {r}_{H} \cdot cos ( {sin}^{- 1} ( \frac{{r}_{U}}{{r}_{H}} ) ) \leq {d}_{G , HU} < ( {r}_{H} + {r}_{U} )\end{matrix} \qquad [ Equation 14 ]$$

Here, α and β, and s are defined as shown in Equations 15, 16, and 17 below.

$$α = {sin}^{- 1} ( \frac{2 \sqrt{s ( s - {r}_{H} ) ( s - {r}_{U} ) ( s - {d}_{G , HU} )}}{{r}_{H} {d}_{G}} ) \qquad [ Equation 15 ]$$

$$α = {sin}^{- 1} ( \frac{2 \sqrt{s ( s - {r}_{H} ) ( s - {r}_{U} ) ( s - {d}_{G , HU} )}}{{r}_{H} {d}_{G}} ) \qquad [ Equation 16 ]$$

$$s = \frac{{r}_{H} + {r}_{U} + {d}_{G , HU}}{2} \qquad [ Equation 17 ]$$

Assuming that HAPS ground users are randomly and uniformly distributed on the ground surface, an interference probability in the overlapping area resulting from overlapping of HAPS ground-cell service coverages may be calculated as shown in Equation 18 below.

$$\begin{matrix}Pr \{ Interface \} = 1 - Pr \{ \begin{matrix}No ground user exists \\ within the overlapped area\end{matrix} \} \\ = 1 - ( 1 - {\sum }_{i = 1}^{∞} Pr \{ {i}_{th} ground user ∈ {O}_{area} \} ) \\ = 1 - {e}^{- {ρ}_{G} \cdot {O}_{area}}\end{matrix} \qquad [ Equation 18 ]$$

Here, ρ_{G}=N_{G}/C denotes a ground-user density in the ground-cell coverage area, that is, the number of ground users per unit area.

Under a target interference probability condition caused by the overlapping area of ground-cell coverages, a separation distance may be calculated according to various criteria.

A minimum separation distance (straight-line distance) between the HAPS and an adjacent UAV may be calculated as shown in Equation 19 below.

$${D}_{L}^{keep - out} = {arg min}_{{d}_{L}} ( f ( {d}_{L} ) ) \qquad [ Equation 19 ]$$

Here, an interference probability f(d_{L}) is defined as shown in Equation 20 below.

$$f ( {d}_{L} ) = 1 - {e}^{- {ρ}_{G} \cdot {O}_{area} ( {d}_{L} )} \qquad [ Equation 20 ]$$

The range of the interference probability f(d_{L}) is as shown in Equation 21 below.

$$0 < f ( {d}_{L} ) \leq 1 \qquad [ Equation 21 ]$$

A minimum separation distance (straight-line distance) between a user located at the center of the HAPS ground-cell coverage, that is, at coordinates (0, 0, R_{E}) in a 3D space, and an adjacent UAV may be calculated as shown in Equation 22 below.

$${D}_{U}^{keep - out} = {arg min}_{{d}_{U}} ( f ( {d}_{U} ) ) \qquad [ Equation 22 ]$$

Here, an interference probability f(d_{U}) is defined as shown in Equation 23 below.

$$f ( {d}_{U} ) = 1 - {e}^{- {ρ}_{G} \cdot {O}_{area} ( {d}_{U} )} \qquad [ Equation 23 ]$$

The range of the interference probability f(d_{U}) is as shown in Equation 24 below.

$$0 < f ( {d}_{U} ) \leq 1 \qquad [ Equation 24 ]$$

Accordingly, by using Equations 19 and 24, the processor 300 may calculate a separation distance between adjacent aerial networks and a separation distance between an aerial network and a ground cell under a given interference probability. Hereinafter, a method of setting a separation distance between aerial network communication systems according to an embodiment of the present invention will be described.

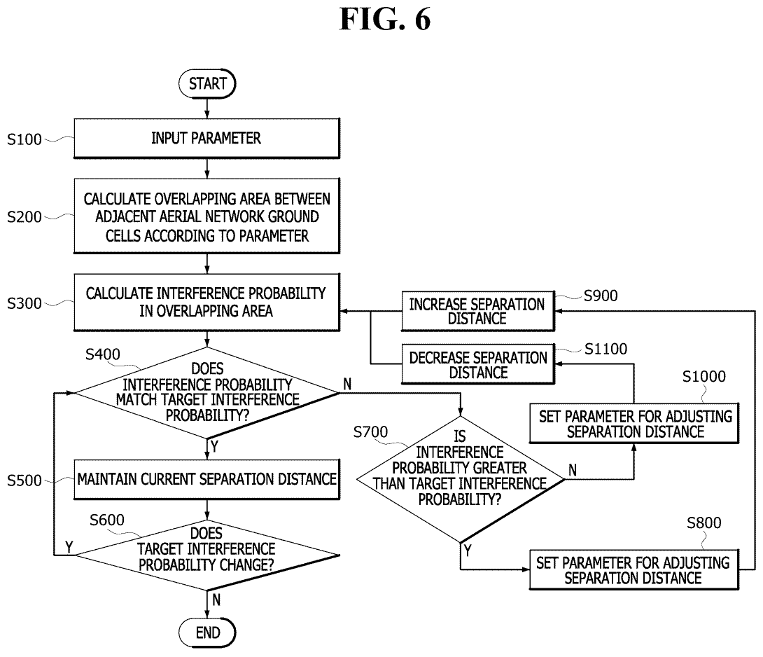

FIG. 6 is a flowchart illustrating a method of setting a separation distance between aerial network communication systems according to one embodiment of the present invention.

Referring to FIG. 6, in operation S100, the processor 300 may receive parameters from the user interface unit 100.

The processor 300 may calculate an overlapping area between adjacent aerial network ground cells according to the received parameters in operation S200 and calculate an interference probability in the calculated overlapping area in operation S300.

In operation S400, the processor 300 may determine whether the interference probability matches a predetermined target interference probability.

As a result of the determination in operation S400, when the interference probability matches the target interference probability, the processor 300 may maintain the current separation distance in operation S500. In this case, the processor 300 may determine whether the target interference probability changes in operation S600.

As a result of the determination in operation S600, when the target interference probability changes, the processor 300 may return to operation S500 to determine whether the separation distance satisfies a newly changed target interference probability and perform subsequent operations.

As a result of determination in operation S400, when the interference probability does not match the target interference probability, the processor 300 may determine whether the interference probability is greater than the target interference probability in operation S700.

As a result of the determination in operation S700, when the interference probability is greater than the target interference probability, the processor 300 may newly set parameters in operation S800. In this case, the processor 300 may receive parameters from the user interface unit 100 as described above or extract parameters from a predetermined lookup table to correct the parameters.

The lookup table may be set for each parameter in various ranges to set the separation distance, and the processor 300 may newly set the parameters by extracting at least one parameter from the lookup table.

The processor 300 may calculate the separation distance according to the corrected parameters, and in this case, may increase the separation distance in operation S900. Subsequently, the processor 300 may return to operation S300 and perform subsequent operations.

As a result of the determination in operation S700, when the interference probability is less than the target interference probability, the processor 300 may newly set parameters by receiving parameters from the user interface unit or extracting parameters from the lookup table in operation S1000. The processor 300 may calculate the separation distance according to the corrected parameters and thus may decrease the separation distance in operation S1100.

According to an aspect of the present invention, it is possible to minimize interference between adjacent aerial network communication systems and improve frequency utilization efficiency by setting a separation distance between aerial network communication systems according to the interference probability caused by overlapping ground-cell coverage.

What is claimed is:

1. An apparatus for setting a separation distance between aerial network communication systems, comprising:
a processor; and
a memory configured to store instructions executed by the processor,
wherein the processor calculates an interference probability in an overlapping area between ground cells of a first aerial network communication system and a second aerial network communication system using at least one parameter of the first aerial network communication system and the second aerial network communication system, and sets a separation distance between the aerial network communication systems based on the interference probability.

2. The system of claim 1, wherein the first aerial network communication system is a high altitude platform station (HAPS), and
the second aerial network communication system is an unmanned aerial vehicle (UAV).

3. The system of claim 1, wherein the parameter includes at least one of a beamwidth of the first aerial network communication system and the second aerial network communication system, an altitude of the first aerial network communication system and the second aerial network communication system, a ground cell radius of the first aerial network communication system and the second aerial network communication system, a ground cell service coverage of the first aerial network communication system and the second aerial network communication system, an elevation angle of the second aerial network communication system with respect to a user of the first aerial network communication system located at coordinates in a three-dimensional (3D) space of a ground cell of the first aerial network communication system, a zenith angle of the second aerial network communication system with respect to a center of the earth, a distance between the first aerial network communication system and the second aerial network communication system, a distance between ground cells of the first aerial network communication system and the second aerial network communication system, and a radius of the ground cells of the first aerial network communication system and the second aerial network communication system.

4. The apparatus of claim 1, wherein the processor calculates the overlapping area using at least one of a separation distance between centers and radii of the ground cells of the first aerial network communication system and the second aerial network communication system.

5. The apparatus of claim 1, wherein the processor compares the interference probability with a predetermined target interference probability corresponding to the overlapping area and sets the separation distance between the aerial network communication systems based on a result of comparison.

6. The apparatus of claim 5, wherein the processor maintains the separation distance when the interference probability matches the target interference probability and determines whether the target interference probability changes.

7. The apparatus of claim 5, wherein the processor adjusts the parameter to increase the separation distance between the aerial network communication systems when the interference probability is greater than the target interference probability, and adjusts the parameter to decrease the separation distance between the aerial network communication systems when the interference probability is less than the target interference probability.

8. The apparatus of claim 1, wherein the separation distance between the aerial network communication systems is a separation distance between the first aerial network communication system and the second aerial network communication system.

9. The apparatus of claim 8, wherein the separation distance between the first aerial network communication system and the second aerial network communication system is calculated based on the predetermined target interference probability according to the overlapping area of the first aerial network communication system and the second aerial network communication system.

10. The apparatus of claim 1, wherein the separation distance between the aerial network communication systems is a separation distance between a user located at a center of a ground-cell coverage of the first aerial network communication system and the second aerial network communication system.

11. The apparatus of claim 10, wherein the separation distance between the user located at the center of the ground-cell coverage of the first aerial network communication system and the second aerial network communication system is calculated based on a predetermined target interference probability according to an overlapping area of the user located at the center of the ground-cell coverage of the first aerial network communication system and the second aerial network communication system.

12. A method of setting a separation distance between aerial network communication systems, comprising:
calculating, by a processor, an interference probability in an overlapping area between ground cells of a first aerial network communication system and a second aerial network communication system using at least one parameter of the first aerial network communication system and the second aerial network communication system; and
setting, by the processor, a separation distance between the aerial network communication systems based on the interference probability.

13. The method of claim 12, wherein the parameter includes at least one of a beamwidth of the first aerial network communication system and the second aerial network communication system, an altitude of the first aerial network communication system and the second aerial network communication system, a ground cell radius of the first aerial network communication system and the second aerial network communication system, a ground cell service coverage of the first aerial network communication system and the second aerial network communication system, an elevation angle of the second aerial network communication system with respect to a user of the first aerial network communication system located at coordinates in a 3D space of a ground cell of the first aerial network communication system, a zenith angle of the second aerial network communication system with respect to a center of the earth, a distance between the first aerial network communication system and the second aerial network communication system; a distance between ground cells of the first aerial network communication system and the second aerial network communication system, and a radius of the ground cells of the first aerial network communication system and the second aerial network communication system.

14. The method of claim 12, wherein the calculating of the interference probability includes calculating, by the processor, the overlapping area using at least one of a separation distance between centers and radii of the ground cells of the first aerial network communication system and the second aerial network communication system.

15. The method of claim 12, wherein the setting of the separation distance between the aerial network communication systems includes, by the processor, comparing the interference probability and a predetermined target interference probability corresponding to the overlapping area, and correcting the separation distance between the aerial network communication systems according to a result of the comparing.

16. The method of claim 15, wherein the setting of the separation distance between the aerial network communication systems includes, by the processor, maintaining the separation distance to determine whether the target interference probability changes when the interference probability matches the target interference probability, and adjusting the parameter to increase the separation distance between the aerial network communication systems when the interference probability is greater than the target interference probability and adjusting the parameter to decrease the separation distance between the aerial network communication systems when the interference probability is less than the target interference probability.

17. The method of claim 12, wherein the separation distance between the aerial network communication systems is a separation distance between the first aerial network communication system and the second aerial network communication system.

18. The method of claim 17, wherein the separation distance between the first aerial network communication system and the second aerial network communication system is calculated based on the predetermined target interference probability according to the overlapping area of the first aerial network communication system and the second aerial network communication system.

19. The method of claim 12, wherein the separation distance between the aerial network communication systems is a separation distance between a user located at a center of the ground-cell coverage of the first aerial network communication system and the second aerial network communication system.

20. The method of claim 19, wherein the separation distance between the user located at the center of the ground-cell coverage of the first aerial network communication system and the second aerial network communication system is calculated based on a predetermined target interference probability according to an overlapping area of the user located at the center of the ground-cell coverage of the first aerial network communication system and the second aerial network communication system.
